(19) United States
(12) Patent Application Publication
(10) Pub. No.: US 2016/0039462 A1
(43) Pub. Date: Feb. 11, 2016

(54) CROSS-MEMBER FOR THE BASE REGION OF A MOTOR VEHICLE BODY SHELL STRUCTURE, A METHOD FOR PRODUCING A CROSS-MEMBER AND A MOTOR VEHICLE BODY SHELL STRUCTURE

(71) Applicant: DAIMLER AG, Stuttgart (DE)

(72) Inventor: Manfred KEMPF, Vogt (DE)

(73) Assignee: Daimler AG, Stuttgart (DE)

(21) Appl. No.: 14/775,513

(22) PCT Filed: Mar. 10, 2014
(86) PCT No.: PCT/EP2014/000608

§ 371 Date: Sep. 11, 2015

(30) Foreign Application Priority Data
Mar. 13, 2013 (DE) 10 2013 004 306.9

(51) Int. Cl. B62D 21/08; B62D 29/00; B62D 25/20

(52) U.S. Cl. CPC B62D 21/08; B62D 25/20; B62D 29/008

(57) ABSTRACT

A crossmember for the base region of a motor vehicle shell structure is disclosed. The crossmember is a light metal or a light metal alloy, preferably aluminum or an aluminum alloy, preferably magnesium or a magnesium alloy, at least in regions and is produced at least in regions by forging.

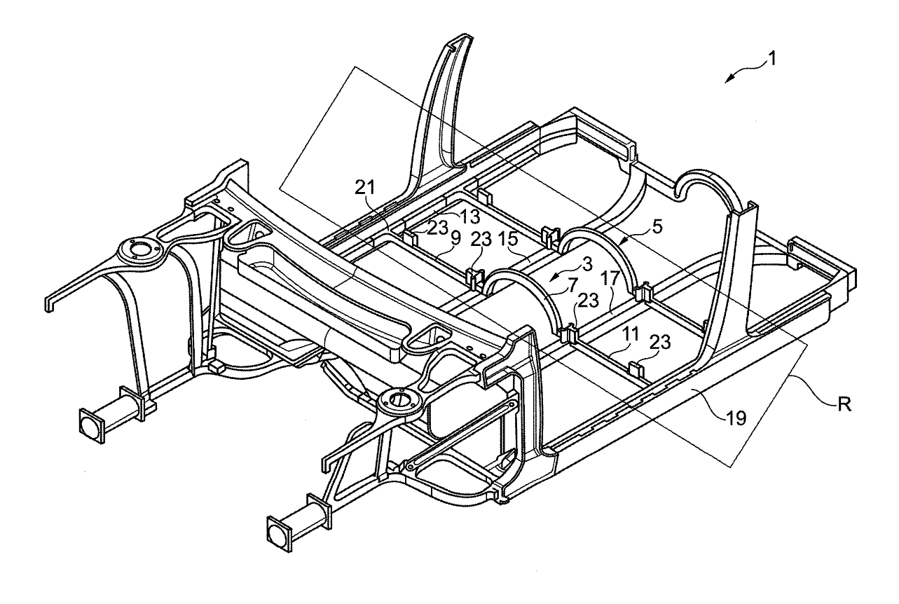

### BACKGROUND AND SUMMARY OF THE INVENTION

The invention relates to a crossmember for the base region of a motor vehicle shell structure, a method for the production of a crossmember, as well as a motor vehicle shell structure.

Crossmembers of the type referred to here are known. A carrier structure of a seat crossmember emerges from the German publication DE 10 2010 018 638 A1 which consists of an elongated profile element which extends in the vehicle transverse direction and which is produced from sheet steel and is hot stamped by hot forming. Alternatively, it is also known to form a crossmember at least in regions as a casting part, as a tube or as an extruded profile. These embodiments are disadvantageous in that they are able to be improved, in particular with regard to their mechanical strength, even in the case of a side impact.

The object of the invention is therefore to create a crossmember which does not have the disadvantages referred to. The object of the invention is furthermore to create a method for the production of such a crossmember as well as a motor vehicle shell structure, wherein the disadvantages referred to are also avoided.

The object is solved by a crossmember of the present invention being created. This is distinguished in that it is produced at least in regions by forging. Using the forging, a highly-compacted structure results due to which the crossmember achieves extraordinarily high mechanical strength. This is particularly advantageous in the case of a side impact. During forging, a fiber orientation in the structure can also be adjusted according to stress, wherein fibers can be compacted, in particular, in regions with high mechanical stress. In this way, the strength of the crossmember is further increased. Ductile regions can also be integrated. Due to the increased strength, it is possible to ensure, at the same time, sufficient stress resistance in the case of a side impact and to reduce the wall thickness of the crossmember. This takes into account the concept of lightweight construction. Furthermore, during forging, it is possible to produce the member having—seen along its longitudinal extension—a varying cross-sectional course, wherein it is in particular possible to form regions with high mechanical stress with a greater cross-section than regions with lower mechanical stress. The wall thickness of the member therefore does not have to be designed for a maximum mechanical stress, but rather can be designed according to need. This in turn leads to material savings, such that the crossmember can be lighter overall than this is the case, for example, for a casting part which must be produced with as far as possible constant wall thickness which is designed for maximum stress. The mechanically highly-compacted structure of a forged part is free of cavities, whereby it is able to be mechanically stressed and involves a lower test effort than this is the case for a casting part. Furthermore, in the case of a forged component, significantly less post-processing is required. It occurs that a comparably simple approach is depicted to forge the crossmember at least in regions. It is therefore possible to produce a comparably light crossmember which is able to be highly stressed in a cost-effective manner in the scope of the method using relatively simple means.

Preferably, the crossmember is forged from at least one heated light metal blank. This additionally takes into account the concept of lightweight construction. Together with the advantage that the crossmember can be produced with a discontinuous cross-section and additionally with variable rib/beading structures which run in the direction of force depending on stress, in particular in the case of a use of a heated light metal blank it is possible to provide the crossmember with a relatively complex structure which is preferably filigree at least in regions. Overall, due to the reduced wall thickness and the use of a lightweight material, the lightweight construction requirements are thus taken into account. In addition to a light metal component, a further improvement of the functional properties can be achieved by the use of hybrid materials such as, for example, steel, fiber-reinforced plastic. Additionally, the crossmember can contain a double profile according to requirement, wherein this is fixed by forged connection pieces.

The crossmember according to the invention is distinguished in that it comprises a light metal or a light metal alloy at least in regions. Preferably, the crossmember consists of a light metal or a light metal alloy. This is, in particular, the case if the crossmember is forged from at least one heated light metal blank. Preferably, the crossmember comprises aluminum or an aluminum alloy at least in regions. Particularly preferably, the crossmember consists of aluminum or an aluminum alloy. In particular, a higher-strength aluminum alloy is preferably used for the crossmember at least in regions. Alternatively or additionally, the crossmember preferably comprises magnesium or a magnesium alloy. A preferred exemplary embodiment of the crossmember consists of magnesium or a magnesium alloy. The selection of these materials at least for a region of the crossmember enables a particularly light formation of the same and thus takes into account the concept of lightweight construction.

A forged crossmember is also preferred which is distinguished in that the crossmember is formed as a seat crossmember. Here, it comprises at least one receiver for a seat of the motor vehicle. Alternatively or additionally, the crossmember comprises at least one receiver for a seat rail of the motor vehicle. Additionally, the seat crossmember can be formed in such a way that it has, for example, rollover structures, for example for a convertible. Additionally, more connection points for a hybrid base/rear wall panelling and, for example, control units/media can be integrated into the crossmember.

A preferred exemplary embodiment of the crossmember is formed as a single shell. The crossmember can therefore have a forged shell structure which comprises one shell. Another exemplary embodiment of the crossmember comprises a double-shell structure. In this case, the crossmember is preferably formed from two shells which are joined to each other and which are preferably both forged. These shells can also consist of different materials according to construction requirements.

A crossmember is preferred which is distinguished in that it is formed of several parts. Preferably, the crossmember comprises a curved central part which is provided to bridge the central tunnel region of a motor vehicle shell structure. Preferably, side parts connect to the central part on both sides, wherein the central part connects the two side parts to each other. The side parts are preferably not curved, but rather are formed to be straight. Thus they run within the motor vehicle shell structure preferably substantially, preferably exactly, in the vehicle transverse direction. In a functional embodiment as a receiving segment for an energy system and the included media, a continuous, even profile can also be selected for the crossmember. Also, in one embodiment, the seat crossmember can be completely submerged in connection with the base segment and the battery part. The connection occurs in this case with the joining of the energy generation carrier.

Preferably, at least one of the side parts is produced by forging, particularly preferably from a heated light metal blank. In one exemplary embodiment of the crossmember, both side parts are produced by forging, particularly preferably from a heated light metal blank. Alternatively or additionally, it is possible that the central part is produced by forging, particularly preferably from a heated light metal blank.

The individual components, so in particular the two side parts and the central part, are preferably screwed, riveted or glued to one another. Alternatively, it is also possible that they are welded to one another. In the case of use of simple joining techniques such as, for example, gluing, riveting or screwing, heat input is reduced in comparison to welding, whereby a component distortion is reduced. Thus, both the crossmember and a motor vehicle shell structure which has this can be produced with dimensional accuracy. One exemplary embodiment of the crossmember is preferred in which the side parts are welded to the central part. Hereby, in a simply manner, a particularly stable, fixed connection which is able to be stressed of the side parts to the central part can be achieved. During welding, the side parts are connected to the central part, preferably in a non-positive and firmly bonded, if necessary even positive manner.

One exemplary embodiment of the crossmember is also preferred which is distinguished in that the crossmember is produced entirely in one piece by forging, particularly preferably from a heated light metal blank. This represents a formation of the crossmember which is particularly procedurally economical. Preferably, the crossmember is produced in one piece along its entire extension from a first side to a second side of a motor vehicle shell structure by forging, particularly preferably from a heated light metal blank. It hereby obtains a phenomenally high level of stability and mechanical strength along its entire extension, wherein at the same time it can be formed with reduced wall thickness which is adapted variably according to need and thus can be formed to be particularly light.

A crossmember is also preferred which is distinguished in that a connection node for the connection to a longitudinal member and/or sill of the motor vehicle shell structure is provided on it. Preferably, the at least one connection node is forged to the crossmember or forged on the crossmember. With the aid of the at least one connection node, the crossmember is preferably connected to the motor vehicle shell structure in a sill region and/or in the region of a central tunnel. This can occur with the aid of mechanical means, in particular by means of screwing or riveting, by gluing and/or by welding. It is thereby possible without a problem to connect a forged crossmember to adjacent elements of a motor vehicle shell structure by means of welding.

A crossmember is also preferred which is distinguished in that at least one functional structure is provided on it. The at least one functional structure is preferably selected from a group consisting of a seat receiver, a seat rail receiver, depending on the vehicle a receiver for a rollover structure and a receiving element or fixing element for a storage volume. The storage volume is preferably an energy store, in particular a battery and/or a tank, in particular a fuel tank. In particular if a receiving element or a fixing element for a battery or a fuel tank is provided on the crossmember, additional parts for such a receiver can be omitted, and at the same time protection of the storage volume is ensured in the case of a side impact.

The at least one functional structure is preferably forged into the crossmember, forged to the crossmember or forged on the crossmember. Here, forging into indicates that the functional structure is reforged at least in regions with the material of the crossmember. Forging to indicates that a connection of the functional structure to the crossmember by forging, preferably by hybrid forging, is caused, wherein, for example, recesses are provided in a fixing region of the functional structure, through which material of the crossmember is passed from a first side, wherein the material engages behind the fixing region on a second side such that a non-positive and firmly bonded connection is caused. Forging on indicates that the functional structure is formed from the material of the crossmember during forging.

It is preferably possible that the crossmember is formed as a hybrid component, wherein it is particularly preferably produced by hybrid forging. Here, the crossmember comprises more than one region, wherein at least one further region is not produced by massive forming, in particular not by forging. It is, however, possible, that the at least one further region is connected to the forged region by forging. It is particularly possible here for the at least one further region to be forged into the forged region completely, to be forged to this or to be reforged in regions with the material of the forged region. Thus, in this case, a complete forging in indicates that the forged-in region is completely surrounded on all sides by the material of the forged region, while a reforging indicates that the further region is surrounded only in regions by the material of the forged region. A forged-in region can, for example, be an inlay, a reinforcement structure, in particular a reinforcement inlay or a reinforcement core. With the aid of such structures, it is possible to increase the stability and mechanical strength of the crossmember further or to adjust it according to need.

The object is also solved by a method for producing a crossmember for the floor region of a motor vehicle shell structure. In particular, with the aid of the method, a crossmember is preferably produced according to one of the previously described exemplary embodiments. The method is distinguished in that the crossmember is produced at least in regions by forging. Preferably, the crossmember is produced from at least one heated light metal blank. Hereby, the advantages are achieved which have already been stated in connection with the crossmember.

In a preferred embodiment of the method, the crossmember is produced as a single or double-shell component by forging.

In an exemplary embodiment of the method, it is provided that the crossmember undergoes heat treatment at least in regions. It is possible that the entire crossmember undergoes heat treatment. Alternatively or additionally, it is possible that the crossmember undergoes a partial or local heat treatment. With the aid of the heat treatment, it is possible to adjust the component properties of the crossmember, in particular the solidity, viscosity, ductility and/or hardness thereof according to need. Particularly preferably, these material properties are adjusted locally according to need. Hereby, targeted regions of the crossmember can be adjusted to be more ductile, more viscous, or stronger. Thus, overall, the stability of the crossmember can in particular be improved with regard to a side impact.

A method is preferred in which at least one region of the crossmember is produced by hot forging. Herein, higher degrees of forming are able to be achieved. Also, one embodiment of the method is preferred in which at least one region of the crossmember is produced by warm forging. Herein, lower degrees of forming are able to be presented than in hot forging; however, the risk of scaling a surface of the crossmember in the case of use of a steel component is lower. Finally, a method is also preferred in which at least one region of the crossmember is produced by cold forging. Herein, lower degrees of forging are able to be presented, yet there exists no risk of scaling of the surface. Strain hardening can further improve the properties.

It is shown in any case that, in particular in the case of a production of the crossmember in one piece by forging, a component number can be reduced in the motor vehicle shell structure. At the same time it is possible to pursue a modular strategy by using identical parts or a concept uniformity. At the same time, a higher assurance of the transverse rigidity of the component is possible.

The method is able to be implemented cost-efficiently by tool-connected forging such as die forging. Therein, the crossmember and the connection nodes thereof to adjacent elements of the motor vehicle shell structure can preferably be produced at the same lime.

The description of the crossmember on the one hand and the method on the other hand are to be understood to be complementary to each other. In particular, method steps which have been described—possibly implicitly—in connection with the crossmember are steps of one embodiment of the method, preferably individually or in combination with one another. Conversely, features which have been described—possibly implicitly—in connection with the method are preferably features of an exemplary embodiment of the crossmember, preferably individually or in combination with one another.

The object is finally also solved by a motor vehicle shell structure. This is distinguished by a crossmember provided in the base region of the motor vehicle shell structure according to one of the previously described exemplary embodiments. Alternatively, the motor vehicle shell structure is distinguished by a crossmember which is produced by a method according to one of the previously described exemplary embodiments. Thus, the advantages which have already been presented in connection with the crossmember and the method are achieved for the motor vehicle shell structure.

A motor vehicle shell structure is preferred which is distinguished in that a central part of the crossmember is formed to be curved. This bridges a central tunnel region of the motor vehicle shell structure. The crossmember is connected laterally on both sides and in the region of the central tunnel to the longitudinal members, in particular sills, of the motor vehicle shell structure. Preferably, the crossmember is mechanically connected to the longitudinal members, in particular sills, and/or to the central tunnel region, for example by screwing and/or riveting, or is welded. It is also possible that the crossmember is glued to the longitudinal members, in particular the sills, and/or the central tunnel region.

The invention is illustrated in greater detail below by means of the drawing.

### BRIEF DESCRIPTION OF THE DRAWING

The single FIGURE shows an exemplary embodiment of a motor vehicle shell structure having two crossmembers according to one exemplary embodiment.

### DETAILED DESCRIPTION OF THE DRAWING

The FIGURE shows an exemplary embodiment of a motor vehicle shell structure 1, wherein a region of the motor vehicle shell structure 1 is identified with a rectangle R by a first crossmember 3 and a second crossmember 5 being provided. In the depicted exemplary embodiment of the motor vehicle shell structure 1, the first crossmember 3 and the second crossmember 5 are formed to be identical, such that only the first crossmember 3 is described in more detail below. The statements concerning this first crossmember 3 also apply equally to the second crossmember 5.

In another exemplary embodiment of the of the motor vehicle shell structure 1, it is possible that two different crossmembers 3, 5 or only one crossmember or more than two identical or different crossmembers are provided.

The crossmember 3 which is provided for the base region of the motor vehicle shell structure 1 has a curved central part 7 which bridges a central tunnel region of the motor vehicle shell structure 1. A first side part 9 and a second side part 11 are provided on both sides of the central part 7 which are preferably connected to the central part 7 mechanically, in particular screwed, riveted or glued to this. Alternatively, it is possible that the side parts 9, 11 are forged to the central part 7.

At least one of the side parts 9, 11 and/or the central part 7 are produced by forging, from at least one heated light metal blank. Alternatively, it is possible that the entire crossmember 3 is produced in one piece by forging from a heated light metal blank.

Connection nodes to connect to the longitudinal members 13, 15, 17, 19 of the motor vehicle shell structure are provided on the crossmember 3. Such a connection node is identified here by way of example with the reference numeral 21. The connection nodes 21 are preferably forged to the crossmember or are forged on this from the material of the crossmember. The crossmember 3 is preferably welded to the longitudinal members 13, 15, 17, 19 in the region of the connection nodes. Alternatively, it is also possible that the crossmember is screwed, riveted or glued to the longitudinal members 13, 15, 17, 19.

In one exemplary embodiment, it is also possible that the connection nodes 21 are screwed or riveted onto the crossmember 3, in particular onto the side parts 9 and/or onto the central part 7 or are welded or glued to this.

Receivers 23 for at least one seat and/or at least one seat rail are preferably formed or forged, preferably in one piece, on the side parts 9, 11 and/or on the central part 7. It is also possible that the receivers 23 are forged to the side parts 9, 11 and/or the central part 7 or are forged into the material thereof, in particular by hybrid forging. In this case, they are formed as separate components. Preferably, four receivers 23 are provided for four seat rails and/or for two seats.

Preferably, at least one receiver or fixing element for a storage volume, in particular for an energy store, is provided on at least one of the side parts 9, 11. In particular, preferably at least one receiver or fixing element for a battery and/or for a tank, in particular a fuel tank, is provided. Also, this at least one receiver or fixing element is preferably forged in one piece on the side part 9, 11. Alternatively it is also possible for it to be forged to the at least one side element 9, 11 or to be forged into this as a separate component in the manner of hybrid forging.

Overall it is shown that the crossmember is formed to be able to be highly stressed mechanically and at the same time to be light and compact. It is thus able to be produced using simple means in a cost-efficient manner within the scope of the method. The motor vehicle shell structure equipped with the crossmember has increased stability in the case of a side impact.

1.-9. (canceled)

10. A crossmember of a base region of a motor vehicle shell structure, wherein the crossmember comprises a light metal or a light metal alloy at least in regions and is produced by forging at least in regions.

11. The crossmember according to claim 10, wherein the light metal is aluminum and the light metal alloy is an aluminum alloy.

12. The crossmember according to claim 10, wherein the light metal is magnesium and the light metal alloy is a magnesium alloy.

13. The crossmember according to claim 10, wherein the crossmember is a seat crossmember and wherein the seat crossmember has at least one receiver for a seat and/or a seat rail of a motor vehicle.

14. The crossmember according to claim 10, wherein the crossmember includes a curved central part and two side parts which connect on respective sides to the central part and wherein at least one of the two side parts and/or the central part is produced by forging.

15. The crossmember according to claim 10, wherein the crossmember is produced along an entire extension of the crossmember from a first side of the motor vehicle shell structure to a second side of the motor vehicle shell structure in a single piece by forging.

16. The crossmember according to claim 10, wherein the crossmember includes at least one connection node, wherein the at least one connection node connects the crossmember to a longitudinal carrier of the motor vehicle shell structure, and wherein the at least one connection node is forged to the crossmember or forged on the crossmember.

17. The crossmember according to claim 10, wherein at least one functional structure is disposed on the crossmember and wherein the at least one functional structure is forged into the crossmember, forged to the crossmember, or forged on the crossmember.

18. The crossmember according to claim 17, wherein the at least one functional structure is a seat receiver, a seat rail receiver, or a receiving or fixing element for a storage volume.

19. The crossmember according to claim 18, wherein the storage volume is an energy store and wherein the energy store is a battery or a tank.

20. A method for producing a crossmember of a base region of a motor vehicle shell structure, comprising the step of:
producing the crossmember at least in regions by forging from at least one heated light metal blank.

21. A motor vehicle shell structure, comprising:
a crossmember disposed in a base region of the motor vehicle shell structure produced according to claim 20.

22. The motor vehicle shell structure according to claim 21, wherein a central part of the crossmember is curved and bridges a central tunnel region of the motor vehicle shell structure and wherein the crossmember is connected laterally on respective sides of the crossmember and in a region of the central tunnel region to respective longitudinal members of the motor vehicle shell structure.
